(19) United States
(12) Patent Application Publication
(10) Pub. No.: US 2016/0199779 A1
(43) Pub. Date: Jul. 14, 2016

(54) METHOD AND INSTALLATION FOR THE PURIFICATION OF EXHAUST GASES, HAVING A REGENERATIVE POST-COMBUSTION INSTALLATION

(71) Applicant: THYSSENKRUPP INDUSTRIAL SOLUTIONS AG, Essen (DE)

(72) Inventors: Kathrin ROHLOFF, Hamburg (DE); Melanie FLAßPÖHLER, Dortmund (DE); Timo STENDER, Fröndenberg (DE)

(73) Assignee: THYSSENKRUPP INDUSTRIAL SOLUTIONS AG, Essen (DE)

(21) Appl. No.: 14/917,227

(22) PCT Filed: Aug. 5, 2014
(86) PCT No.: PCT/EP2014/002144

§ 371 Date: Mar. 7, 2016

(30) Foreign Application Priority Data
Sep. 11, 2013 (DE) 10 2013 109 977.7

(51) Int. Cl. B01D 53/58; B01D 53/76; B01D 53/56; B01D 53/62; B01D 53/72

(52) U.S. Cl. CPC B01D 53/58; B01D 53/62; B01D 53/72; B01D 53/56; B01D 53/76

(57) ABSTRACT

Improved methods and systems for purifying exhaust gases using regenerative post-combustion systems help reduce operating problems and increase service life of such regenerative post-combustion systems. One such method may involve preheating an exhaust gas to be purified before feeding the exhaust gas into a regenerative post-combustion system. The exhaust gas may be preheated in at least one preheating stage to temperatures between 100° C. and 250° C., for instance, preferably between 100° C. and 200° C., and most preferably between 120° C. and 150° C. Moreover, one regenerative post-combustion system may include a preheating stage, two heat stores, and an oxidation zone disposed between the heat stores for oxidizing harmful constituents present in the exhaust gas.

The invention relates to a method and a system for purifying exhaust gases using a regenerative post-combustion system.

DE 10 2009 055 942 B4 discloses a method and a device for purifying exhaust gases, in particular as known from cement clinker production, wherein a regenerative thermal post-combustion system is used, with which carbon compounds are oxidized at a temperature of above 800° C. in a multistage combustion chamber and nitrogen oxides are thermally reduced with supply of a nitrogen-hydrogen compound. The post-combustion system, for this purpose, has at least two regenerators that are packed with heat-storage bodies and are linked by a combustion chamber, wherein the exhaust gas alternately heats at least one of the regenerators. In the combustion chamber the carbon compounds are oxidized at a temperature of above 850° C. and the hot clean gas formed is taken off via the other regenator. In a following cycle, the sequence of passage through the two generators is reversed, permitting continuous operation with uptake and release of the heat energy of the exhaust gas. Using this method, efficiencies of heat recovery of more than 90% are achieved.

Simultaneous reduction of the nitrogen oxides proceeds by injecting ammonia water at two positions respectively upstream and downstream of the combustion chamber. In the case of certain exhaust gases, as arise, for example, in the cement and mineral industries, however, operating problems can occur in the regenerative post-combustion. Particularly problematic substances in this case are the sulfur and/or chlorine loads in the exhaust gases. Thus, in particular corrosions or deposits and/or adhesions on the regenerators can occur which in turn can increase the pressure drop and cause system shutdown for cleaning the regenerators. The operating costs increase correspondingly thereby. To permit a fault-free system operation, and high service life, typically scrubbers are used that remove harmful acid gases from the exhaust gas stream. In the cement process, in what is termed the “combined operation”, a raw mill is situated in the exhaust gas line, which raw mill likewise permits, by adsorptive processes, removal of the pollutants. In the case of high sulfur and/or chlorine loads, however, complete removal of the pollutants cannot be guaranteed, in such a manner that the above described operating problems occur in the regenerative post-combustion system. In addition to the shedding of ammonia salts which are formed by reaction with ammonia compounds, mercury, for example, can also be precipitated. There is heating in these precipitation zones, temporary emission peaks can occur that exceed the permitted thresholds.

The object of the invention is therefore to improve the method and system for purifying exhaust gases using a regenerative post-combustion system in such a manner that operating problems of the post-combustion system are reduced and the service life of the system is increased.

According to the invention, this object is achieved by the features of claims 1 and 10.

In the method according to the invention for purifying exhaust gases using a regenerative post-combustion system, the exhaust gases that are to be purified, before they are fed into the regenerative post-combustion system, are preheated in at least one preheating stage to temperatures between 100° C. and 250° C., preferably between 100° C. and 200° C., and most preferably between 120° C. and 150° C.

The system according to the invention for carrying out the above method provides, in addition to a regenerative post-combustion system, at least one upstream preheating stage in which the exhaust gases that are to be purified are preheated to the above temperatures.

The exhaust gases that are to be purified are, in particular, exhaust gas of the cement and mineral industries. The preheating according to the invention of the exhaust gases that are to be purified can prevent the acid constituents present in the exhaust gas from falling below the dew point, substantially preventing the reaction with ammonia compounds to form ammonia salts.

Further embodiments of the invention are subject matter of the subclaims.

The regenerative post-combustion system preferably comprises at least one first heat store and a second heat store and an oxidation zone arranged therebetween, wherein the exhaust gas that is preheated in the at least one preheating stage is further heated in at least one of the heat stores alternately, harmful constituents present in the exhaust gas, such as hydrocarbon compounds, oxidize in the oxidation zone and the resultant purified exhaust gas is taken off via the at least one other heat store.

The exhaust gas that is to be purified or a mixture of various gas streams can be heated up in the preheating stage, for example by at least one indirect heat exchanger, wherein the heat in the heat exchanger is transferred, for example by means of a hot gas stream with or without a heat transfer medium such as, for example, thermal oil, or by means of heat pipes. The hot gas stream can be, in particular, the purified exhaust gas of the regenerative post-combustion system. However, it would also be conceivable to use preheater exhaust gas and/or cooling gas of a cement production process as hot gas, in whole or in part. In addition, there is the possibility additionally to increase or adjust the temperature of the exhaust gas that is to be purified by mixing it with other gas streams such as, for example, bypass gas, cooler exhaust air or gas streams from drying systems.

It would also be conceivable to design the preheating stage as a combustion chamber and/or to provide a burner for heating up the exhaust gas that is to be purified. The amount of fuel fed via the burner or the combustion chamber can in this case be dimensioned in such a manner that no further fuel, or a correspondingly reduced amount of fuel, need be fed in the regenerative post-combustion system.

In the regenerative post-combustion system, in addition to the oxidation of the hydrocarbons present in the exhaust gas, a reduction of nitrogen oxides by injection of an ammonia-containing reducing agent can also proceed. For the improved reduction of the nitrogen oxides and/or oxidation of the hydrocarbons, the at least one first heat store and/or second heat store can be equipped for reducing nitrogen oxides and/or oxidizing the hydrocarbons at least in part with catalytically active material.

Further embodiments of the invention are described in more detail hereinafter with reference to the description of two exemplary embodiments and the drawing.

In the drawing,

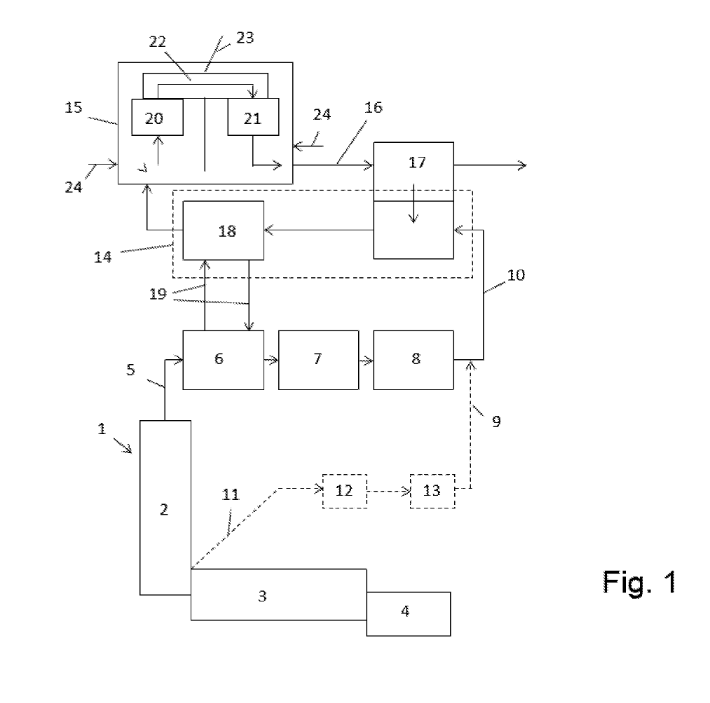

FIG. 1 shows a system for purifying exhaust gases using a regenerative post-combustion system and an upstream preheating stage with two heat exchangers and

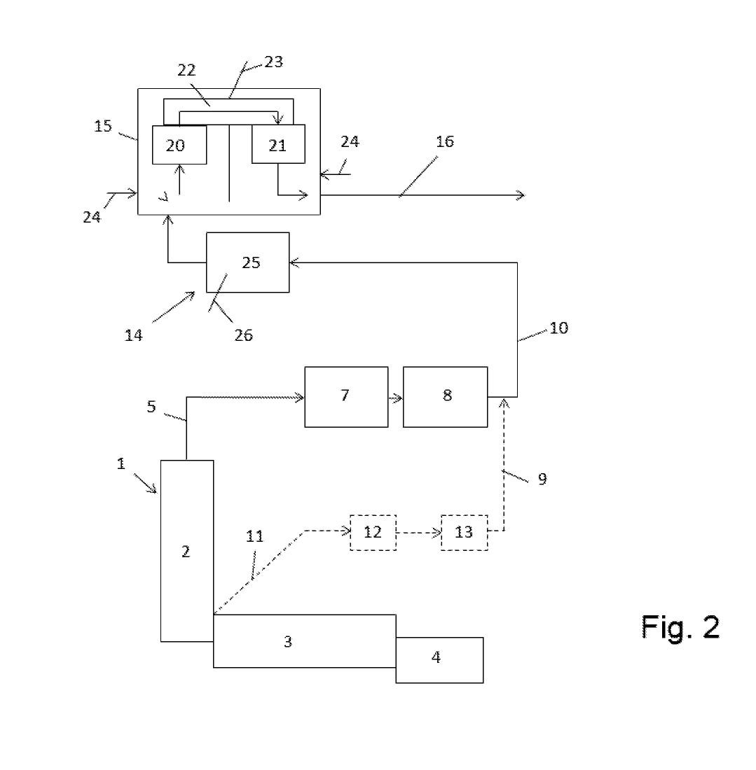

FIG. 2 shows a system for purifying exhaust gases using a regenerative post-combustion system having a preheating stage designed as a combustion chamber.

FIG. 1 shows schematically with the reference signs 1 to 8 a system for cement clinker production. In this case, first cement raw flour 1 is preheated in a preheater 2 operated with the exhaust gases of a rotary kiln 3 and optionally in part calcined before the preheated raw flour is finally fired directly or via a calciner, that is not shown in more detail, in the rotary kiln 3. The fired cement clinker is then cooled in the clinker cooler 4. The preheater exhaust gas 5 leaving the preheater 2 is cooled in a heat exchanger 6 from, for example 400° C. to 320° C., before it is used in a raw mill 7 for drying raw material. The preheater exhaust gas 5, after the raw mill 7, has a temperature in part below 100° C., and is dedusted in a subsequent exhaust gas filter 8. The dedusted preheater exhaust gas 5 is optionally mixed with a prepurified bypass exhaust gas 9 and forms the exhaust gas 10 that is to be purified. The optional bypass exhaust gas is taken off via the bypass line 11 that branches off in the region of the intake of the rotary kiln 3, cooled in a bypass quench 12 and dedusted in a filter 13.

The exhaust gas 10 that is to be purified is first fed to a preheating stage 14 before it arrives at the regenerative post-combustion system 15 and leaves the post-combustion system as purified exhaust gas 16.

The preheating stage 14 is formed in the exemplary embodiment shown by a heat exchanger 17 and a second heat exchanger 18 subsequent thereto. The first heat exchanger 17 is designed as a gas-gas heat exchanger and transfers the heat of the purified exhaust gas 16 to the exhaust gas 10 that is to be purified. The second heat exchanger 18 acts together with the heat exchanger 6, wherein the heat of the preheater exhaust gas 5 is transferred, for example via a heat transfer medium 19, between the two heat exchangers 6 and 18. The exhaust gas 10 that is to be purified is preheated in the preheating stage 14 from a temperature of sometimes below 100° C. to temperatures between 100° C. and 250° C., preferably between 100° C. and 200° C., and most preferably between 120° C. and 150° C., before it enters into the regenerative post-combustion system 15.

The regenerative post-combustion system 15, in the exemplary embodiment shown, provides a first heat store 20, a second heat store 21 and an oxidation zone 22 arranged therebetween, wherein the exhaust gas 10 that is preheated in the preheating stage 14 is further heated in one of the two heat stores, harmful constituents, such as hydrocarbon compounds, present in the exhaust gas in the oxidation zone 22 oxidize and the resultant purified exhaust gas 16 is taken off via the other heat exchanger. In the oxidation zone, a burner 23, in particular a natural gas burner, can be provided. At least one of two heat stores can in this case be equipped, inter alia, for reducing nitrogen oxides and/or for oxidizing hydrocarbons, at least in part with catalytically active material. In addition, means 24 are provided for injecting an ammonia-containing reducing agent.

FIG. 2 shows a second exemplary embodiment in which the preheating stage 14, instead of the heat exchangers 17 and 18, comprises a combustion chamber 25 which comprises, for example, a burner 26, in particular a natural-gas burner. The exhaust gas 10 that is to be purified that in turn is composed of the preheater 2 exhaust gas 5 that is conducted via the raw mill 7 and dedusted, and optionally a prepurified bypass gas 9 and optionally another hot gas, is heated up correspondingly in the combustion chamber 25. The desired temperature in this case must be dimensioned in such a manner that any pollutant constituents in the first or second heat exchanger 20, 21 of the regenerative post-combustion system 15 do not fall below the dew point. If the fuel supplied in the upstream combustion chamber 25 is not completely oxidized, it is conducted together with the exhaust gas to the regenerative post-combustion system 15. There, further oxidation takes place in order to avoid unwanted secondary emissions. A feed of additional fuels via the burner 23 could be dispensed with in the regenerative post-combustion system if the energy of the slip fuels and the carbon monoxide content and hydrocarbon content that is to be decreased is sufficient. Otherwise, the feed of fuels via the burner 23 is correspondingly reduced.

The heating of the exhaust gas 10 that is to be purified by means of one or more hot gases in the preheating stage is, however, not restricted to the exemplary embodiment shown in FIG. 1. For instance, other available hot gases, such as, for example, the cooler exhaust air, can also be utilized. In addition, a combination of at least one heat exchanger and one burner or one combustion chamber and also the above described mixing and/or separate heating of partial gas streams, is also conceivable. Elevating the temperature of the exhaust gases that are to be purified before entry into the regenerative post-combustion system can prevent the temperature falling below the acid dew point and/or the reaction with ammonia compounds to form ammonium salts and as a result, corrosions and deposits, in particular in the region of the heat store, can be reliably avoided, in such a manner that faultless system operation and a high service life is made possible. In addition, said measures offer the possibility of reducing the primary energy required and/or to optimize the system operation with respect to the achievable rate of reduction and/or to optimize the electrical consumption and/or to optimize the necessary system size.

1.-15. (canceled)

16. A method for purifying exhaust gas using a regenerative post-combustion system, the method comprising:
preheating the exhaust gas that is to be purified at least in part in a preheating stage to temperatures between 100 degrees Celsius and 250 degrees Celsius; and
feeding the preheated exhaust gas into the regenerative post-combustion system.

17. The method of claim 16 further comprising:
heating the exhaust gas alternately in at least one of a first heat store and a second heat store of the post-combustion system;
oxidizing harmful constituents in the exhaust gas in an oxidation zone of the post-combustion system; and
removing a resultant purified exhaust gas via one of the first and second heat stores.

18. The method of claim 16 wherein the preheating of the exhaust gas comprises preheating the exhaust gas to be purified with a heat exchanger.

19. The method of claim 18 further comprising transferring heat of a hot gas stream using a heat transfer medium in the heat exchanger at least in part to the exhaust gas to be purified, wherein a temperature of the hot gas stream is greater than a temperature of the exhaust gas to be purified before preheating.

20. The method of claim 18 further comprising transferring heat of a hot gas stream in the heat exchanger to the exhaust gas to be purified, wherein a temperature of the hot gas stream is greater than a temperature of the exhaust gas to be purified before preheating.

21. The method of claim 20 wherein the hot gas stream comprises at least in part a resultant purified exhaust gas from the regenerative post-combustion system.

22. The method of claim 16 wherein the exhaust gas to be purified is at least in part an exhaust gas from at least one of a cement industry or a mineral industry.

23. The method of claim 16 wherein the preheating of the exhaust gas comprises preheating the exhaust gas to be purified with a burner in the preheating stage.

24. The method of claim 23 further comprising inputting an amount of fuel fed by way of the burner such that no further fuel or a corresponding reduced amount of fuel need be inputted in the regenerative post-combustion system.

25. The method of claim 16 wherein the preheating stage is configured as a combustion chamber.

26. The method of claim 25 further comprising inputting an amount of fuel fed by way of the combustion chamber such that no further fuel or a corresponding reduced amount of fuel need be inputted in the regenerative post-combustion system.

27. The method of claim 16 further comprising reducing at least one of carbon monoxide, hydrocarbons, or nitrogen oxides in the regenerative post-combustion system.

28. A system for purifying exhaust gas according to the method of claim 16, the system comprising a regenerative post-combustion system and a preheating stage upstream of the regenerative post-combustion system.

29. A system for purifying exhaust gas, the system comprising:
a preheating stage in which the exhaust gas that is to be purified is preheated at least in part to temperatures between 100 degrees Celsius and 250 degrees Celsius; and
a regenerative post-combustion system downstream of the preheating stage, the regenerative post-combustion system comprising:
a first heat store,
a second heat store, and
an oxidation zone disposed between the first and second heat stores.

30. The system of claim 29 wherein the first and second heat stores are configured to at least one of reduce nitrogen oxides or oxidize hydrocarbons at least in part with catalytically active material.

31. The system of claim 29 wherein the upstream preheating stage comprises at least one of a heat exchanger, a burner, or a combustion chamber.

32. The system of claim 29 wherein the preheating stage consists of a combination of at least one heat exchanger and at least one combustion chamber.
